(19) United States
(12) Patent Application Publication
(10) Pub. No.: US 2025/0187350 A1
(43) Pub. Date: Jun. 12, 2025

(54) RECORDING DEVICE AND CONTROL METHOD FOR RECORDING DEVICE

(71) Applicant: SEIKO EPSON CORPORATION, Tokyo (JP)

(72) Inventors: Atsushi SUMII, SHIOJIRI-SHI (JP); Hiroki CHINO, MATSUMOTO-SHI (JP); Mitsuhiro KOSEKI, CHINO-SHI (JP); Daisuke TANAKA, SHIOJIRI-SHI (JP)

(21) Appl. No.: 18/973,626

(22) Filed: Dec. 9, 2024

(30) Foreign Application Priority Data
Dec. 8, 2023 (JP) 2023-207901

(51) Int. Cl. B41J 11/00; B41J 2/165; B41J 13/08; B41J 25/304; B41J 29/17; B41J 29/20

(52) U.S. Cl. CPC B41J 11/0015; B41J 2/16511; B41J 11/0085; B41J 13/08; B41J 25/304; B41J 29/17; B41J 29/20

(57) ABSTRACT

A recording device includes a transport belt, a recording unit, a destaticization unit that destaticizes a medium, a cleaning unit that cleans the transport belt, and a control unit. The control unit rotates the transport belt while the recording unit is at a separation position, until a contact portion of the transport belt passes through the cleaning unit, the contact portion contacting with the destaticization unit restored from a retraction position to a destaticization position.

The present application is based on, and claims priority from JP Application Serial Number 2023-207901, filed Dec. 8, 2023, the disclosure of which is hereby incorporated by reference herein in its entirety.

### BACKGROUND

### 1. Technical Field

The present disclosure relates to a recording device and a control method for a recording device.

### 2. Related Art

JP-A-2022-116534 describes a recording device including a transport belt that transports a medium by electrostatic suction, a recording unit that records an image on the medium, and a destaticization unit that destaticizes the medium. The destaticization unit destaticizes the medium on the transport belt, and thus the medium is easily sucked onto the transport belt.

The destaticization unit is configured to move between a destaticization position of contacting the transport belt and a retraction position of being retracted from the transport belt. For example, when a medium jam occurs, the destaticization unit moves to the retraction position. The destaticization unit is away from the transport belt, and thus the medium is easily removed.

In the recording device described above, a foreign matter such as paper powder generated from a medium, fibers, and dust may adhere to the destaticization unit. When the destaticization unit moves, a foreign matter may fall off from the destaticization unit onto the transport belt. When the transport belt to which a foreign matter adheres rotates, the foreign matter may adhere to the recording unit. When the foreign matter adheres to the recording unit, recording quality may be degraded.

### SUMMARY

In order to solve the above-mentioned problem, a recording device includes a transport belt configured to transport a medium by electrostatic suction, a recording unit configured to record an image on a medium being transported by the transport belt, a destaticization unit positioned upstream in a transport direction of the medium with respect to the recording unit and configured to destaticize the medium transported by the transport belt, a cleaning unit configured to contact the transport belt to clean the transport belt, and a control unit, wherein the recording unit is configured to move between a recording position of approaching the transport belt and a separation position of being away from the transport belt, the destaticization unit is configured to move between a destaticization position of contacting the transport belt and a retraction position of being retracted from the transport belt, and, when the destaticization unit is retracted from the destaticization position to the retraction position, and then the destaticization unit is restored from the retraction position to the destaticization position, the control unit rotates the transport belt while the recording unit is at the separation position, until a contact portion of the transport belt passes through the cleaning unit, the contact portion contacting the destaticization unit restored to the destaticization position.

In order to solve the above-mentioned problem, a control method for a recording device including a transport belt configured to transport a medium by electrostatic suction, a recording unit configured to record an image on a medium being transported by the transport belt, a destaticization unit positioned upstream in a transport direction of the medium with respect to the recording unit and configured to destaticize the medium transported by the transport belt, and a cleaning unit configured to contact the transport belt to clean the transport belt, the recording unit being configured to move between a recording position of approaching the transport belt and a separation position of being away from the transport belt, the destaticization unit being configured to move between a destaticization position of contacting the transport belt and a retraction position of being retracted from the transport belt, the control method includes, when the destaticization unit is retracted from the destaticization position to the retraction position, and then the destaticization unit is restored from the retraction position to the destaticization position, rotating the transport belt while the recording unit is at the separation position, until a contact portion of the transport belt passes through the cleaning unit, the contact portion contacting the destaticization unit restored to the destaticization position.

### BRIEF DESCRIPTION OF THE DRAWINGS

FIG. 1 is a schematic diagram illustrating on embodiment of a recording device.

FIG. 2 is a schematic diagram in which a recording unit is displaced from the state illustrated in FIG. 1 to a separation position.

FIG. 3 is a cross-sectional view illustrating a destaticization unit and a cleaning unit.

FIG. 4 is a cross-sectional view in which the destaticization unit is displaced from the state illustrated in FIG. 3 to a retraction position.

FIG. 5 is a side view in which a displacement operation is started.

FIG. 6 is a side view in which the displacement operation is terminated.

FIG. 7 is a side view in which a contact part passes through the cleaning unit.

FIG. 8 is a flowchart illustrating a collection operation.

FIG. 9 is a flowchart illustrating a collection operation different from FIG. 8.

FIG. 10 is a flowchart illustrating a collection operation different from FIG. 8 and FIG. 9.

FIG. 11 is a flowchart illustrating a collection operation different from FIG. 8, FIG. 9, and FIG. 10.

### DESCRIPTION OF EMBODIMENTS

With reference to the drawings, one embodiment of a recording device is described below. The recording device is an ink-jet printer that records images such as letters and photographs by ejecting ink, which is an example of liquid, to a medium such as sheets and fabric, for example.

### Recording Device

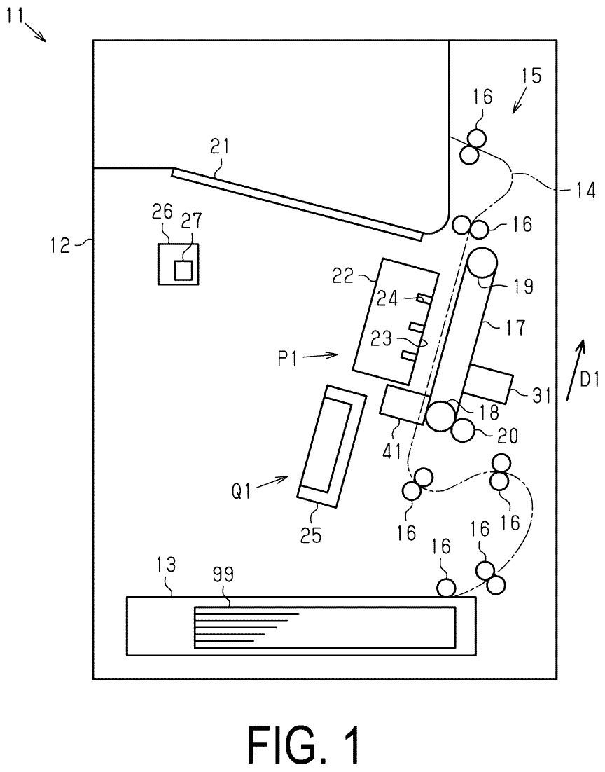

As illustrated in FIG. 1, a recording device 11 includes a housing 12.

The recording device 11 includes an accommodation unit 13. The accommodation unit 13 is configured to accommodate a medium 99. For example, the accommodation unit 13 is a cassette that can be drawn from the housing 12. The accommodation unit 13 accommodates a plurality of media 99 stacked thereon.

The recording device 11 includes a transport path 14. The transport path 14 is a path in which the medium 99 is transported. The transport path 14 extends inside the housing 12. For example, the transport path 14 extends so that the medium 99 is discharged from the accommodation unit 13 to the outside of the housing 12. While the medium 99 is transported in the transport path 14, an image is recorded thereon. The medium 99 is transported in the transport path 14, and thus is discharged to the outside of the housing 12.

The recording device 11 includes a transport unit 15. The transport unit 15 is configured to transport the medium 99. The transport unit 15 transports the medium 99 along the transport path 14 from the accommodation unit 13. For example, the transport unit 15 includes one or more rollers 16. The roller 16 is provided at a position along the transport path 14.

The transport unit 15 includes a transport belt 17. The transport belt 17 is configured to transport the medium 99 by electrostatic suction. The transport belt 17 uses an electrostatic force to suck the medium 99 onto the outer circumferential surface of the transport belt 17. In this manner, the transport belt 17 supports the medium 99. In one example, the transport belt 17 supports the medium 99 in a posture inclined with the horizontal direction. The posture of the medium 99 is stabilized by electrostatic suction.

The transport belt 17 rotates to transport the medium 99. In FIG. 1, the transport belt 17 rotates in a clockwise direction to transport the medium 99. The transport belt 17 transports the medium 99 in a transport direction D1. In one example, the transport direction D1 is an obliquely upward direction. The transport belt 17 transports the medium 99 in the transport direction D1 by electrostatic suction while preventing the medium 99 from falling.

The transport unit 15 includes one or more pulleys. In one example, the transport unit 15 includes a first pulley 18 and a second pulley 19. In one example, the first pulley 18 and the second pulley 19 are arrayed in the transport direction D1 in the stated order. The transport belt 17 is wound around the pulleys. As the pulleys rotate, the transport belt 17 rotates.

The recording device 11 includes a charging unit 20. The charging unit 20 contacts with the transport belt 17. Specifically, the charging unit 20 contacts with the outer circumferential surface of the transport belt 17. The charging unit 20 charges the transport belt 17. The charging unit 20 charges the transport belt 17, and thus the medium 99 is electro-statically sucked onto the transport belt 17. For example, the charging unit 20 is a roller to which a voltage is applied. As the transport belt 17 rotates, the charging unit 20 rotates.

The recording device 11 includes a stacker 21. On the stacker 21, the medium 99 on which an image is recorded is stacked. The stacker 21 is attached to the housing 12. The stacker 21 receives the medium 99 that is discharged to the outside of the housing 12 through the transport path 14.

The recording device 11 includes a recording unit 22. The recording unit 22 is configured to record an image on the medium 99. In one example, the recording unit 22 is configured to eject a liquid onto the medium 99. The recording unit 22 is a so-called head. The recording unit 22 ejects the liquid onto the medium 99 to record an image on the medium 99. The recording unit 22 may record an image on the medium 99 not only with the liquid but also with toner, carbon paper, ink ribbons, or the like.

The recording unit 22 is provided at a position along the transport path 14. The recording unit 22 faces the transport belt 17. The recording unit 22 records an image on the medium 99 transported by the transport belt 17. Specifically, the recording unit 22 ejects the liquid onto the medium 99 on the transport belt 17.

The recording unit 22 includes a nozzle surface 23. One or more nozzles 24 are open in the nozzle surface 23. In one example, in the nozzle surface 23, a plurality of nozzles 24 are open. The recording unit 22 ejects the liquid from the nozzle 24. In one example, the recording unit 22 ejects, from the nozzle 24, the liquid in an oblique direction with respect to the horizontal direction and the vertical direction. Specifically, the recording unit 22 ejects the liquid obliquely downward form the nozzle 24.

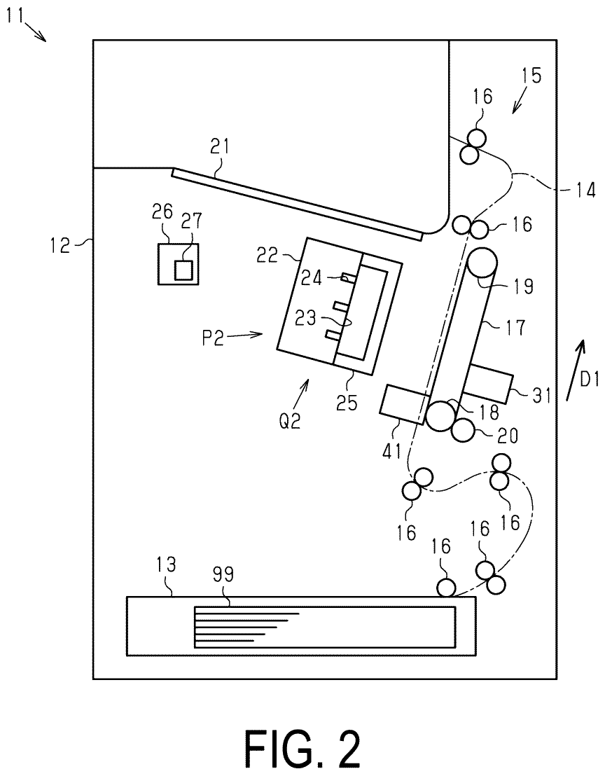

As illustrated in FIG. 1 and FIG. 2, the recording unit 22 is configured to move between a recording position P1 and a separation position P2. The recording position P1 is a position at which the recording unit 22 approaches the transport belt 17. When an image is recorded on the medium 99 on the transport belt 17, the recording unit 22 is at the recording position P1. The separation position P2 is a position at which the recording unit 22 is away from the transport belt 17. A distance between the recording unit 22 at the separation position P2 and the transport belt 17 is larger than a distance between the recording unit 22 at the recording position P1 and the transport belt 17. In a stand-by state, the recording unit 22 is at the separation position P2.

The recording unit 22 is configured to move in a direction vertical to the nozzle surface 23. The recording unit 22 is displaced to the recording position P1 and the separation position P2 by moving in the direction vertical to the nozzle surface 23.

The recording device 11 may include a cap 25. The cap 25 is configured to contact the recording unit 22. Specifically, the cap 25 caps the recording unit 22 at the separation position P2. Capping is an action of covering the nozzle 24 when the cap 25 contacts with the recording unit 22. In one example, the cap 25 contacts with the nozzle surface 23 to cap the recording unit 22. Through capping, a risk of drying the nozzle 24 is lowered.

The cap 25 is configured to move between a stand-by position Q1 and a capping position Q2. The stand-by position Q1 is a position at which the cap 25 stands by. When the recording unit 22 is at the recording position P1, the cap 25 is at the stand-by position Q1. The capping position Q2 is a position between the recording unit 22 and the transport belt 17. When the recording unit 22 is at the separation position P2, the cap 25 is at the capping position Q2. When the recording unit 22 is at the separation position P2, the recording unit 22 is capped by the cap 25.

The recording device 11 includes a control unit 26. The control unit 26 controls the recording device 11. The control unit 26 may be configured by one or more processors that execute various processes in accordance with a computer program. the control unit 26 may be configured by one or more dedicated hardware circuits such as an ASIC that executes at least some of the various types of processing. The control unit 26 may be configured by a circuit including a combination of a processor and a hardware circuit. The processor includes a CPU, and memories such as a RAM and a ROM. The memory stores program code or instructions configured to cause the CPU to execute processes. The memory, that is, a computer readable medium, includes any type of readable mediums that are accessible by general-purpose or dedicated computers.

The recording device 11 may include a counting unit 27. The counting unit 27 is configured to count the number of transported media 99. The counting unit 27 counts the number of media 99 transported by the transport belt 17. In one example, the counting unit 27 is configured by the control unit 26. The control unit 26 functions as the counting unit 27 by executing a predetermined program code. For example, the counting unit 27 counts the number of transported media, based on a job received by the control unit 26. The job is a signal including an instruction for recording an image. The counting unit 27 may be a sensor that detects the medium 99 transported in the transport path 14.

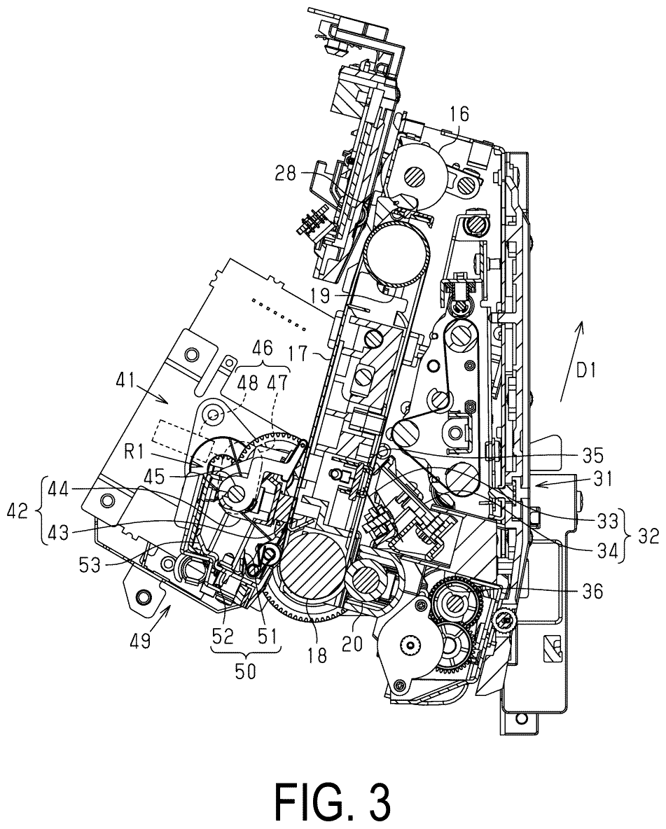

As illustrated in FIG. 3, the recording device 11 may include a peeling unit 28. The peeling unit 28 is configured to peel off the medium 99 from the transport belt 17. The peeling unit 28 contacts with the outer circumferential surface of the transport belt 17. The peeling unit 28 and the second pulley 19 are positioned to sandwich the transport belt 17. For example, the peeling unit 28 contacts with the medium 99 after recording to peel off the medium 99 from the transport belt 17. In one example, the peeling unit 28 is a scraper.

The recording device 11 includes a cleaning unit 31. The cleaning unit 31 is configured to clean the transport belt 17. The cleaning unit 31 contacts with the transport belt 17 to clean the transport belt 17. Cleaning is removing a foreign matter adhering to the transport belt 17. A foreign matter such as paper powder generated from the medium 99, fibers, and dust may adhere to the transport belt 17. When a foreign matter adheres to the transport belt 17, the foreign matter on the transport belt 17 may adhere to the recording unit 22, or the medium 99 is less likely to be sucked onto the transport belt 17. Such a risk is lowered when the transport belt 17 is cleaned by the cleaning unit 31.

The cleaning unit 31 contacts with the transport belt 17. The cleaning unit 31 contacts with the outer circumferential surface of the transport belt 17. In one example, the cleaning unit 31 contacts a portion of the transport belt 17, which moves in a direction opposite to the transport direction D1. The cleaning unit 31 cleans a portion of the transport belt 17, which is a portion directly before sucking the medium 99. With this, the medium 99 can be sucked onto the portion the transport belt 17, which is a portion directly after cleaning by the cleaning unit 31.

The cleaning unit 31 includes a cleaning blade 32. The cleaning blade 32 contacts with the transport belt 17. Specifically, the cleaning blade 32 contacts with the outer circumferential surface of the transport belt 17. The cleaning blade 32 scrapes off a foreign matter from the transport belt 17.

The cleaning blade 32 includes a blade portion 33 and a support portion 34. The blade portion 33 contacts with the outer circumferential surface of the transport belt 17. For example, the blade portion 33 is formed of a resin sheet. The support portion 34 supports the blade portion 33.

The cleaning unit 31 includes a cleaning guide 35. The cleaning guide 35 supports the transport belt 17. The cleaning guide 35 contacts with the inner circumferential surface of the transport belt 17. The cleaning guide 35 and the cleaning blade 32 are positioned to sandwich the transport belt 17. The cleaning guide 35 supports a portion of the transport belt 17, which is pressed by the cleaning blade 32. With this, the cleaning blade 32 can strongly contact the transport belt 17, and hence a foreign matter can easily be removed from the transport belt 17.

The cleaning unit 31 includes the cleaning box 36. The cleaning box 36 is positioned to receive a foreign matter scraped off by the cleaning blade 32. The cleaning box 36 accommodates a foreign matter scraped off by the cleaning blade 32. The cleaning box 36 supports the cleaning blade 32. Specifically, the support portion 34 is fixed to the cleaning box 36.

The recording device 11 includes a destaticization mechanism 41. The destaticization mechanism 41 is configured to destaticize the medium 99. Specifically, the destaticization mechanism 41 destaticizes the medium 99 on the transport belt 17. When the medium 99 is sucked onto the transport belt 17, the medium 99 is charged similarly to the transport belt 17. In this state, the medium 99 is charged so as to reduce a suction force of the transport belt 17. The destaticization mechanism 41 destaticizes the medium 99 to maintain a suction force of the transport belt 17.

The destaticization mechanism 41 includes a destaticization unit 42. The destaticization unit 42 destaticizes the medium 99 transported by the transport belt 17. The destaticization unit 42 destaticizes the medium 99 by contacting the medium 99 on the transport belt 17.

The destaticization unit 42 is positioned upstream of the recording unit 22 in the transport direction D1. The destaticization unit 42 contacts with a portion of the transport belt 17, which is a portion between a portion wound around the first pulley 18 and a portion facing the recording unit 22. The destaticization unit 42 destaticizes the medium 99 that is directly after being sucked onto the transport belt 17. With this, the recording unit 22 can record an image on the medium 99 while the medium 99 is strongly sucked onto the transport belt 17.

The destaticization unit 42 includes a brush portion 43 and a holder portion 44. The brush portion 43 is a portion that contacts with the medium 99. For example, the brush portion 43 includes conductive resin fibers. When the brush portion 43 contacts with the medium 99, electric charges are removed from the medium 99. The brush portion 43 destaticizes the medium 99, and a foreign matter adheres thereto. The holder portion 44 holds the brush portion 43.

The destaticization unit 42 may include a rotary shaft 45. The destaticization unit 42 is configured to rotate about the rotary shaft 45. For example, the rotary shaft 45 is configured to rotate integrally with the brush portion 43.

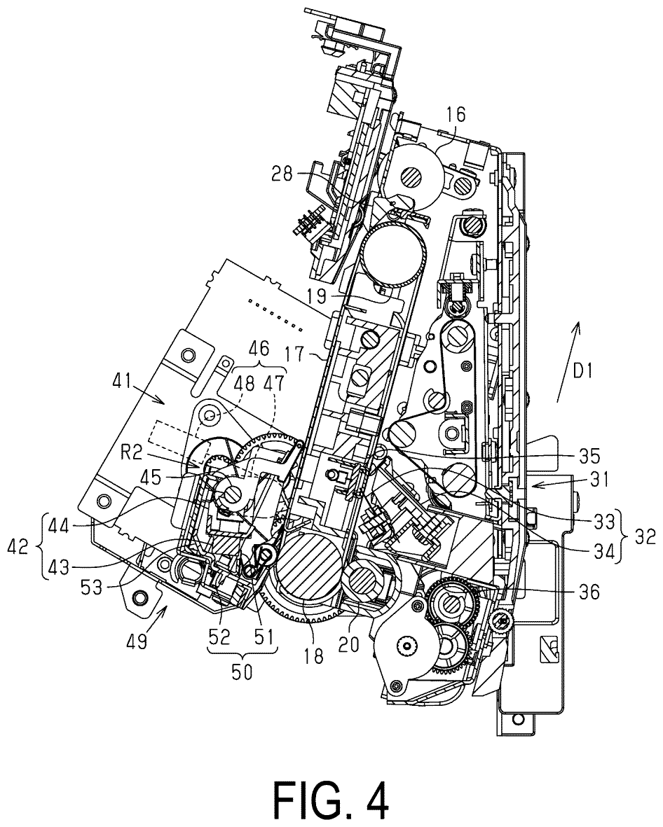

As illustrated in FIG. 3 and FIG. 4, the destaticization unit 42 is configured to move between a destaticization position R1 and a retraction position R2. The destaticization position R1 is a position of destaticizing the medium 99. At the destaticization position R1, the destaticization unit 42 contacts with the transport belt 17. At the destaticization position R1, the destaticization unit 42 can contact the medium 99 on the transport belt 17. When an image is recorded on the medium 99, the destaticization unit 42 is at the destaticization position R1. For example, when the recording unit 22 is at the recording position P1, the destaticization unit 42 is at the destaticization position R1. The destaticization unit 42 is normally at the destaticization position R1. The retraction position R2 is a position at which the destaticization unit 42 is retracted from the transport belt 17. At the retraction position R2, the destaticization unit 42 does not contact the transport belt 17.

The destaticization unit 42 is displaced from the destaticization position R1 to the retraction position R2 at a predetermined timing. For example, when the recording device 11 requires maintenance, the destaticization unit 42 is at the retraction position R2. For example, when a jam of the medium 99 occurs on the transport belt 17, the destaticization unit 42 is displaced from the destaticization position R1 to the retraction position R2. For example, when a collection unit 49, which is described later, is caused to collect a foreign matter, the destaticization unit 42 is displaced from the destaticization position R1 to the retraction position R2. The destaticization unit 42 is retracted from the destaticization position R1 to the retraction position R2, and then is restored from the retraction position R2 to the destaticization position R1.

The destaticization unit 42 rotates about the rotary shaft 45 to move between the destaticization position R1 and the retraction position R2. In FIG. 3, when the destaticization unit 42 is displaced from the destaticization position R1 to the retraction position R2, the destaticization unit 42 rotates in a clockwise direction. When the destaticization unit 42 is displaced from the retraction position R2 to the destaticization position R1, the destaticization unit 42 rotates in a counterclockwise direction. For example, the destaticization unit 42 may move linearly to be displaced to the destaticization position R1 and the retraction position R2. For example, the destaticization unit 42 is displaced by a driving force of a motor, which is omitted in illustration.

When the destaticization unit 42 is restored from the retraction position R2 to the destaticization position R1, the rotation direction of the destaticization unit 42 is opposite to the rotation direction of the transport belt 17. In FIG. 3, when the destaticization unit 42 is displaced from the retraction position R2 to the destaticization position R1, the rotation direction thereof is a counterclockwise direction. In contrast, the rotation direction of the transport belt 17 is a clockwise direction. The destaticization unit 42 contacts with the transport belt 17 while being displaced from the retraction position R2 to the destaticization position R1. In other words, the destaticization unit 42 contacts with the transport belt 17 before arriving at the destaticization position R1. When the transport belt 17 rotates, the destaticization unit 42 receives a frictional force from the transport belt 17 so as to be displaced from the retraction position R2 to the destaticization position R1. Therefore, the destaticization unit 42 is easily restored from the retraction position R2 to the destaticization position R1 by contacting the rotating transport belt 17.

The destaticization mechanism 41 may include a restoration mechanism 46. The restoration mechanism 46 is a mechanism that restores the destaticization unit 42 from the retraction position R2 to the destaticization position R1. For example, the restoration mechanism 46 applies, to the destaticization unit 42, a driving force of rotating the destaticization unit 42 in a direction of displacing the destaticization unit 42 from the retraction position R2 to the destaticization position R1. With this, the destaticization unit 42 is easily restored from the retraction position R2 to the destaticization position R1.

The restoration mechanism 46 includes a link member 47 and a spring member 48. The link member 47 is attached to the destaticization unit 42. Specifically, the link member 47 is attached to the destaticization unit 42 so as to rotate integrally with the rotary shaft 45. The spring member 48 is coupled to the link member 47. For example, one end of the spring member 48 is coupled to the link member 47, and the other end of the spring member 48 is coupled to the housing 12. The spring member 48 pulls the link member 47. Specifically, the spring member 48 pulls the link member 47 so that the destaticization unit 42 rotates in a direction of displacing the destaticization unit 42 from the retraction position R2 to the destaticization position R1. In FIG. 3, the spring member 48 pulls the link member 47 so that the link member 47 rotates in a counterclockwise direction.

The destaticization mechanism 41 may include the collection unit 49. The collection unit 49 is configured to collect a foreign matter from the destaticization unit 42. In one example, the collection unit 49 collects a foreign matter from the destaticization unit 42 by contacting the destaticization unit 42 moving between the destaticization position R1 and the retraction position R2. The collection unit 49 collects a foreign matter from the destaticization unit 42. With this, the destaticization performance of the destaticization unit 42 is maintained.

The collection unit 49 includes a collection wiper 50. The collection wiper 50 collects a foreign matter from the destaticization unit 42 by contacting the destaticization unit 42. Specifically, the collection wiper 50 collects a foreign matter adhering to the brush portion 43 by contacting the brush portion 43. For example, the collection unit 49 may collect a foreign matter from the destaticization unit 42 by sucking the brush portion 43.

The collection wiper 50 includes a wiper portion 51 and a holding portion 52. The wiper portion 51 contacts with the destaticization unit 42. Specifically, the wiper portion 51 contacts with the brush portion 43 in the process of displacing the destaticization unit 42. The wiper portion 51 contacts with the brush portion 43 in the process of displacing the destaticization unit 42 from the destaticization position R1 to the retraction position R2 and the process of displacing the destaticization unit 42 from the retraction position R2 to the destaticization position R1. The wiper portion 51 is positioned so as to overlap with the movement track of the brush portion 43. For example, the wiper portion 51 is formed of a resin sheet. The holding portion 52 holds the wiper portion 51.

The collection unit 49 may include a collection box 53. The collection box 53 is positioned to receive a foreign matter collected by the collection wiper 50. The collection wiper 50 contacts with the brush portion 43, and then a foreign matter falls off from the brush portion 43. The collection box 53 receives the foreign matter falling therefrom. The collection box 53 accommodates a foreign matter scraped off by the collection wiper 50. The collection box 53 supports the collection wiper 50. Specifically, the holding portion 52 is fixed to the collection box 53.

### Operation of Recording Device

Next, an operation of the recording device 11 is described. The recording device 11 executes a predetermined operation by the control unit 26.

The control unit 26 executes a displacement operation. The displacement operation is an operation of displacing the destaticization unit 42 from the destaticization position R1 to the retraction position R2 and then displacing the destaticization unit 42 from the retraction position R2 to the destaticization position R1. The displacement operation is a reciprocating operation of the destaticization unit 42 from the destaticization position R1 to the destaticization position R1. In the displacement operation, the destaticization unit 42 may be displaced from the destaticization position R1 to the retraction position R2, and, after a pose, may be displaced from the retraction position R2 to the destaticization position R1. In the displacement operation, the destaticization unit 42 may be displaced from the destaticization position R1 to the retraction position R2, and, without a pose, may be displaced from the retraction position R2 to the destaticization position R1. For example, when a foreign matter is collected from the destaticization unit 42, the control unit 26 executes the displacement operation. When the displacement operation is executed, the destaticization unit 42 contacts with the collection wiper 50. In this manner, as the displacement operation is executed, the collection unit 49 collects a foreign matter from the destaticization unit 42.

The displacement operation is not limited to an operation where the destaticization unit 42 reciprocates once, and may be an operation where the destaticization unit 42 reciprocates a plurality of times. In this case, the number of times when the destaticization unit 42 contacts with the collection wiper 50 is increased. Thus, a foreign matter is easily removed from the destaticization unit 42.

The control unit 26 executes the displacement operation at a predetermined timing. The control unit 26 collects a foreign matter from the destaticization unit 42 at a predetermined timing. In one example, when the number of transported media counted by the counting unit 27 reaches a predetermined number, the control unit 26 executes the displacement operation. For example, the predetermined number is the number of media at which a foreign matter is expected to accumulate on the brush portion 43.

In the recording device 11, when the displacement operation is executed, a foreign matter may adhere to the transport belt 17. When the destaticization unit 42 is displaced, a foreign matter may fall off from the brush portion 43 onto the transport belt 17. When the destaticization unit 42 is displaced from the destaticization position R1 to the retraction position R2, a foreign matter may adhere to the transport belt 17. When the destaticization unit 42 is displaced from the retraction position R2 to the destaticization position R1, a foreign matter may adhere to the transport belt 17. In particular, when the brush portion 43 is away from the transport belt 17, and the brush portion 43 contacts with the transport belt 17, a foreign matter easily adheres to the transport belt 17.

The control unit 26 executes a cleaning operation in accordance with execution of the displacement operation. In other words, when the destaticization unit 42 is retracted from the destaticization position R1 to the retraction position R2, and then the destaticization unit 42 is restored from the retraction position R2 to the destaticization position R1, the control unit 26 executes the cleaning operation. The cleaning operation is an operation of removing a foreign matter, which adheres to the transport belt 17 during the displacement operation, form the transport belt 17. In the cleaning operation, the control unit 26 rotates the transport belt 17. With this, the cleaning unit 31 collects a foreign matter from the transport belt 17. In the cleaning operation, the control unit 26 stops the transport belt 17 after a foreign matter is collected from the transport belt 17. Due to the cleaning operation, the transport belt 17 from which a foreign matter is removed can transport the medium 99.

The control unit 26 starts the cleaning operation at a predetermined timing with respect to the displacement operation. The control unit 26 may start the cleaning operation before starting the displacement operation. For example, when an instruction of executing the displacement operation is input, the control unit 26 may start the cleaning operation before starting the displacement operation. The control unit 26 may start rotation of the transport belt 17 before retracting the destaticization unit 42 from the destaticization position R1 to the retraction position R2. In other words, the control unit 26 may retract the destaticization unit 42 from the destaticization position R1 to the retraction position R2 after starting rotation of the transport belt 17.

The control unit 26 may start the cleaning operation in the middle of the displacement operation. For example, the control unit 26 may start rotation of the transport belt 17 after retracting the destaticization unit 42 from the destaticization position R1 to the retraction position R2. Specifically, the control unit 26 may start rotation of the transport belt 17 after displacing the destaticization unit 42 from the destaticization position R1 to the retraction position R2 and before restoring the destaticization unit 42 from the retraction position R2 to the destaticization position R1.

The control unit 26 may start the cleaning operation after the displacement operation. For example, the control unit 26 may start rotation of the transport belt 17 after retracting the destaticization unit 42 from the destaticization position R1 to the retraction position R2. Specifically, the control unit 26 may start rotation of the transport belt 17 after retracting the destaticization unit 42 from the destaticization position R1 to the retraction position R2 and restoring the destaticization unit 42 from the retraction position R2 to the destaticization position R1.

The control unit 26 may start the displacement operation and the cleaning operation at the same time. For example, the control unit 26 may retract the destaticization unit 42 from the destaticization position R1 to the retraction position R2, and, at the same time, may start rotation of the transport belt 17. The control unit 26 may restore the destaticization unit 42 from the retraction position R2 to the destaticization position R1, and, at the same time, may start rotation of the transport belt 17.

When the cleaning operation is executed in parallel with the displacement operation, a foreign matter falling off from the destaticization unit 42 disperses on the transport belt 17. In other words, a risk that a foreign matter concentrates at one position on the transport belt 17 is lowered. With this, a foreign matter adhering to the transport belt 17 is easily removed by the cleaning unit 31. Further, when the cleaning operation is executed in parallel with the displacement operation, a time period required for terminating the cleaning operation is reduced as compared to a case in which the cleaning operation is executed after the displacement operation is terminated.

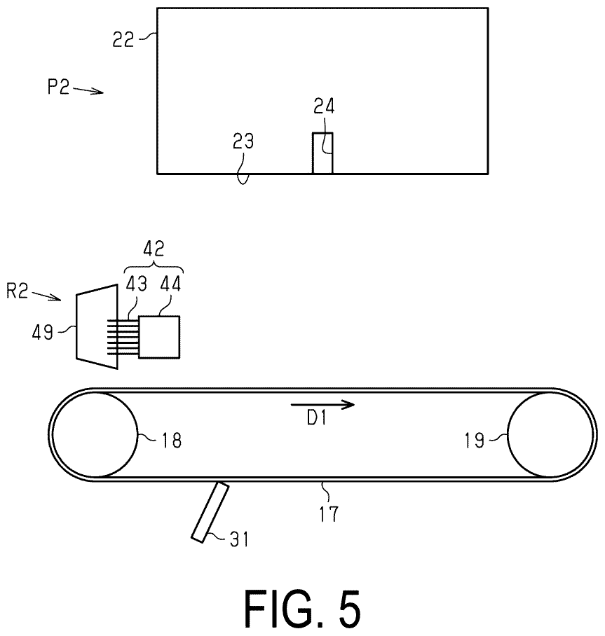

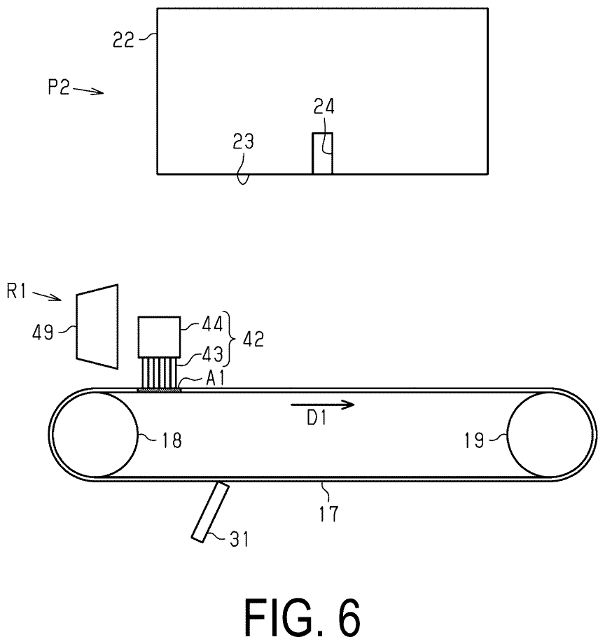

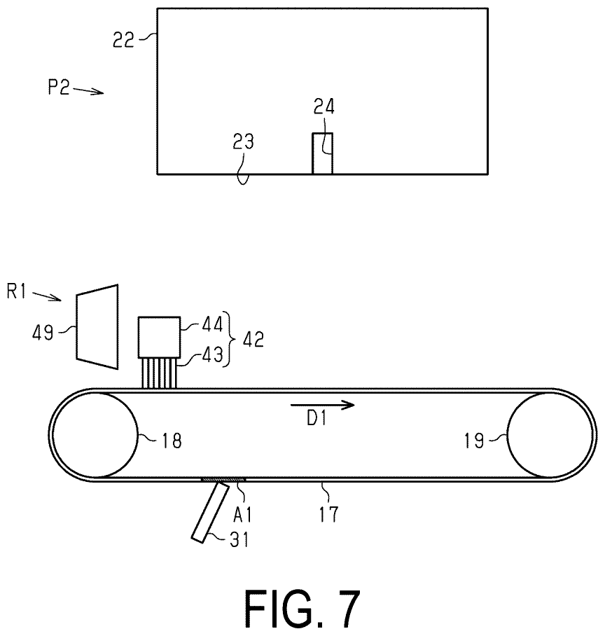

As illustrated in FIG. 5, FIG. 6, and FIG. 7, the control unit 26 rotates the transport belt 17 by a predetermined amount in the cleaning operation. Specifically, in the cleaning operation, the control unit 26 rotates the transport belt 17 until a contact portion A1 passes through the cleaning unit 31. The contact portion A1 is a part of the transport belt 17. The contact portion A1 is a portion of the transport belt 17, with which the destaticization unit 42 contacts at the time of terminating the displacement operation. In other words, the contact portion A1 is a portion of the transport belt 17, with which the destaticization unit 42 restored to the destaticization position R1 contacts. In the displacement operation, when the destaticization unit 42 reciprocates for a plurality of times, the contact portion A1 is a portion of the transport belt 17, with which the destaticization unit 42 restored to the destaticization position R1 lastly contacts. The contact portion A1 passes through the cleaning unit 31. With this, a foreign matter adhering to the transport belt 17 during the displacement operation is removed by the cleaning unit 31. Thus, a risk that the transport belt 17 to which a foreign matter adheres transports the medium 99 is lowered. The control unit 26 stops the transport belt 17 after the contact portion A1 passes through the cleaning unit 31.

In the cleaning operation, the control unit 26 may rotate the transport belt 17 so that the contact portion A1 passes through the cleaning unit 31 for a plurality of times. In this case, a foreign matter is further removed from the transport belt 17. The control unit 26 stops the transport belt 17 after the contact portion A1 passes through the cleaning unit 31 for a plurality of times.

The control unit 26 may rotate the transport belt 17 for a predetermined time period after the destaticization unit 42 is restored from the retraction position R2 to the destaticization position R1. In this case, the contact portion A1 passes through the cleaning unit 31. The transport belt 17 is rotated for a predetermined time period after the destaticization unit 42 is restored from the retraction position R2 to the destaticization position R1. With this, the contact portion A1 may pass through the cleaning unit 31 for a plurality of times.

When the cleaning operation is executed, the control unit 26 places the recording unit 22 at the separation position P2. In other words, the control unit 26 executes while the recording unit 22 is at the separation position P2. The control unit 26 displaces the recording unit 22 to the separation position P2 before starting the cleaning operation. The control unit 26 rotates the transport belt 17 while the recording unit 22 is at the separation position P2.

In the cleaning operation, the transport belt 17 rotates. With this, a foreign matter on the transport belt 17 passes between the recording unit 22 and the transport belt 17. In this state, when the recording unit 22 is at the recording position P1, a foreign matter on the transport belt 17 may adhere to the recording unit 22. When a foreign matter adheres to the recording unit 22, recording quality may be affected. In particular, when a foreign matter adheres to the nozzle surface 23, the nozzle 24, or the like, the liquid may not normally be ejected from the nozzle 24. The cleaning operation is executed while the recording unit 22 is at the separation position P2. Thus, a risk that a foreign matter adheres to the recording unit 22 is lowered. In particular, in one example, the recording unit 22 at the separation position P2 is capped, and hence a foreign matter is further less likely to adhere to the recording unit 22.

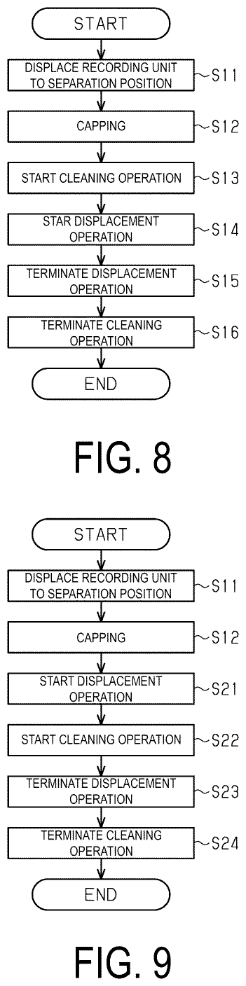

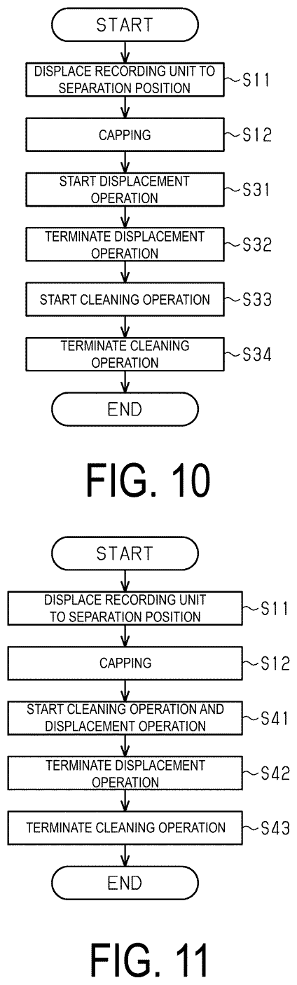

Next, a collection operation is described. The collection operation is an operation of collecting a foreign matter from the destaticization unit 42. The collection operation is an operation including the displacement operation and the cleaning operation. The collection operation is executed when the number of transported media counted by the counting unit 27 reaches the predetermined number. The collection operation may be executed based on an instruction from a user. The flowcharts illustrating in FIG. 8, FIG. 9, FIG. 10, and FIG. 11 are examples of the collection operation. First, the flowchart in FIG. 8 is described.

As illustrated in FIG. 8, in Step S11, the control unit 26 displaces the recording unit 22 to the separation position P2.

In Step S12, the control unit 26 causes the cap 25 to cap the recording unit 22.

In Step S13, the control unit 26 starts the cleaning operation. Specifically, the control unit 26 starts rotation of the transport belt 17. In other words, the control unit 26 starts rotation of the transport belt 17 before retracting the destaticization unit 42 to the retraction position R2.

In Step S14, the control unit 26 starts the displacement operation. Specifically, the control unit 26 retracts the destaticization unit 42 from the destaticization position R1 to the retraction position R2.

In Step S15, the control unit 26 terminates the displacement operation. Specifically, the control unit 26 restores the destaticization unit 42 from the retraction position R2 to the destaticization position R1. In this state, the contact portion A1 is defined in the transport belt 17.

In Step S16, the control unit 26 terminates the cleaning operation. Specifically, the control unit 26 rotates the transport belt 17 until the contact portion A1 passes through the cleaning unit 31. The control unit 26 stops the transport belt 17 after the contact portion A1 passes through the cleaning unit 31. When the processing in Step S16 is terminated, the control unit 26 terminates the collection operation.

Next, the flowcharts in FIG. 9, FIG. 10, and FIG. 11 are described. Each of the flowcharts in FIG. 9, FIG. 10, and FIG. 11 is different from the flowchart in FIG. 8 in that an execution timing of the cleaning operation with respect to the displacement operation is set differently. Thus, each of the flowcharts in FIG. 9, FIG. 10, and FIG. 11 is described, mainly focusing on differences from the flowchart illustrated in FIG. 8.

As illustrated in FIG. 9, the control unit 26 executes Step S21 after Step S12. In other words, the control unit 26 causes the cap 25 to the recording unit 22, and then starts the displacement operation. In this state, the control unit 26 retracts the destaticization unit 42 from the destaticization position R1 to the retraction position R2.

In Step S22, the control unit 26 starts the cleaning operation. Specifically, the control unit 26 starts rotation of the transport belt 17. In other words, the control unit 26 starts rotation of the transport belt 17 after retracting the destaticization unit 42 to the retraction position R2.

In Step S23, the control unit 26 terminates the displacement operation. Specifically, the control unit 26 restores the destaticization unit 42 from the retraction position R2 to the destaticization position R1. In this state, the contact portion A1 is defined in the transport belt 17.

In Step S24, the control unit 26 terminates the cleaning operation. Specifically, the control unit 26 rotates the transport belt 17 until the contact portion A1 passes through the cleaning unit 31. The control unit 26 stops the transport belt 17 after the contact portion A1 passes through the cleaning unit 31. When the processing in Step S24 is terminated, the control unit 26 terminates the collection operation.

As illustrated in FIG. 10, the control unit 26 executes Step S31 after Step S12. In other words, the control unit 26 causes the cap 25 to the recording unit 22, and then starts the displacement operation. In this state, the control unit 26 retracts the destaticization unit 42 from the destaticization position R1 to the retraction position R2.

In Step S32, the control unit 26 terminates the displacement operation. Specifically, the control unit 26 restores the destaticization unit 42 from the retraction position R2 to the destaticization position R1. In this state, the contact portion A1 is defined in the transport belt 17.

In Step S33, the control unit 26 starts the cleaning operation. Specifically, the control unit 26 starts rotation of the transport belt 17. In other words, the control unit 26 starts rotation of the transport belt 17 after restoring the destaticization unit 42 to the destaticization position R1.

In Step S34, the control unit 26 terminates the cleaning operation. Specifically, the control unit 26 rotates the transport belt 17 until the contact portion A1 passes through the cleaning unit 31. The control unit 26 stops the transport belt 17 after the contact portion A1 passes through the cleaning unit 31. When the processing in Step S34 is terminated, the control unit 26 terminates the collection operation.

As illustrated in FIG. 11, the control unit 26 executes Step S41 after Step S12. In other words, the control unit 26 causes the cap 25 to cap the recording unit 22, and then starts the displacement operation and the cleaning operation. In other words, the control unit 26 starts rotation of the transport belt 17 in accordance with retraction of the destaticization unit 42 from the destaticization position R1 to the retraction position R2.

In Step S42, the control unit 26 terminates the displacement operation. Specifically, the control unit 26 restores the destaticization unit 42 from the retraction position R2 to the destaticization position R1. In this state, the contact portion A1 is defined in the transport belt 17.

In Step S43, the control unit 26 terminates the cleaning operation. Specifically, the control unit 26 stops the transport belt 17 after the contact portion A1 passes through the cleaning unit 31. When the processing in Step S43 is terminated, the control unit 26 terminates the collection operation.

### Operations and Effects of Embodiment

Next, operations and effects of the above-mentioned examples are described.
(1) When the destaticization unit 42 is retracted from the destaticization position R1 to the retraction position R2, and then the destaticization unit 42 is restored from the retraction position R2 to the destaticization position R1, the control unit 26 rotates the transport belt 17 while the recording unit 22 is at the separation position P2 until the contact portion A1 passes through the cleaning unit 31. When the destaticization unit 42 is retracted from the destaticization position R1 to the retraction position R2, the destaticization unit 42 is restored from the retraction position R2 to the destaticization position R1, a foreign matter easily adheres from the destaticization unit 42 to the transport belt 17. When the transport belt 17 rotates, a foreign matter adhering to the transport belt 17 is removed by the cleaning unit 31. According to the above-mentioned configuration, the transport belt 17 rotates while the recording unit 22 is at the separation position P2. Thus, a foreign matter adhering to the transport belt 17 is less likely to adhere to the recording unit 22. Therefore, a risk that a foreign matter adheres to the recording unit 22 is lowered.
(2) The control unit 26 retracts the destaticization unit 42 from the destaticization position R1 to the retraction position R2, and then starts rotation of the transport belt 17 while the recording unit 22 is at the separation position P2. According to the above-mentioned configuration, when the destaticization unit 42 is retracted from the destaticization position R1 to the retraction position R2, a foreign matter adhering to the transport belt 17 can effectively be removed by the cleaning unit 31.
(3) The control unit 26 retracts the destaticization unit 42 from the destaticization position R1 to the retraction position R2, and, at the same time, starts rotation of the transport belt 17 while the recording unit 22 is at the separation position P2. According to the above-mentioned configuration, when the destaticization unit 42 is retracted from the destaticization position R1 to the retraction position R2, a foreign matter adhering to the transport belt 17 can effectively be removed by the cleaning unit 31.
(4) The control unit 26 starts rotation of the transport belt 17 while the recording unit 22 is at the separation position P2, and then retracts the destaticization unit 42 from the destaticization position R1 to the retraction position R2. According to the above-mentioned configuration, when the destaticization unit 42 is retracted from the destaticization position R1 to the retraction position R2, a foreign matter falling off therefrom can disperse on the transport belt 17. In other words, a risk that a foreign matter concentrates at one position on the transport belt 17 is lowered. With this, a foreign matter adhering to the transport belt 17 is easily removed by the cleaning unit 31.
(5) The control unit 26 stops the transport belt 17 after the contact portion A1 passes through the cleaning unit 31. According to the above-mentioned configuration, the transport belt 17 from which a foreign matter is removed can transport the medium 99.
(6) The control unit 26 stops the transport belt 17 after the contact portion A1 passes through the cleaning unit 31 for a plurality of times. According to the above-mentioned configuration, a foreign matter adhering to the transport belt 17 can be removed repeatedly by the cleaning unit 31.
(7) The destaticization unit 42 is configured to move between the destaticization position R1 and the retraction position R2 by rotating about the rotary shaft 45. According to the above-mentioned configuration, which is a simple configuration, the destaticization unit 42 can move between the destaticization position R1 and the retraction position R2.
(8) The rotation direction of the transport belt 17 is a direction opposite to the rotation direction of the destaticization unit 42 when the destaticization unit 42 is restored from the retraction position R2 to the destaticization position R1. In the middle of restoring the destaticization unit 42 from the retraction position R2 to the destaticization position R1, the destaticization unit 42 contacts with the transport belt 17. In this state, the destaticization unit 42 receives a frictional force from the rotating transport belt 17. According to the above-mentioned configuration, the destaticization unit 42 is easily restored to the destaticization position R1 by a frictional force received from the transport belt 17.
(9) The collection unit 49 collects a foreign matter from the destaticization unit 42 by contacting the destaticization unit 42 moving between the destaticization position R1 and the retraction position R2. According to the above-mentioned configuration, a risk of degrading the destaticization performance of the destaticization unit 42 is lowered.
(10) When the number of media counted by the counting unit 27 reaches the predetermined number, the control unit 26 retracts the destaticization unit 42 from the destaticization position R1 to the retraction position R2. According to the above-mentioned configuration, the collection unit 49 can collect a foreign matter from the destaticization unit 42 at a suitable timing.
(11) The recording unit 22 at the separation position P2 is capped by the cap 25. According to the above-mentioned configuration, the transport belt 17 can be rotated while the recording unit 22 is capped by the cap 25 until the contact portion A1 passes through the cleaning unit 31. With this, a risk that a foreign matter on the transport belt 17 adheres to the recording unit 22 can further be lowered.

### Modifications

The above-mentioned examples may be modified as follows for implementation. The above-mentioned examples and the following modifications may be combined for implementation insofar as they are not technically inconsistent.
In the collection operation, the control unit 26 may displace the recording unit 22 to the separation position P2 after starting the displacement operation. In the collection operation, the recording unit 22 is only required to be at the separation position P2 before starting the cleaning operation. With this, a risk that a foreign matter on the transport belt 17 adheres to the recording unit 22 can be lowered.
The liquid ejected by the recording unit 22 is not limited to ink, but may be a liquid in which particles of functional materials are dispersed or mixed, or the like, for example. For example, the recording unit 22 may eject liquid containing materials such as electrode materials or pixel materials dispersed or dissolved therein for use in manufacture of liquid crystal displays, electroluminescence displays, surface-emitting displays, and the like.

### Technical Ideas

The following describes technical ideas and operational effects that are derived from the above-described examples and modifications.
(A) A recording device includes a transport belt configured to transport a medium by electrostatic suction, a recording unit configured to record an image on a medium being transported by the transport belt, a destaticization unit positioned upstream in a transport direction of the medium with respect to the recording unit and configured to destaticize the medium transported by the transport belt, a cleaning unit configured to contact the transport belt to clean the transport belt, and a control unit, wherein the recording unit is configured to move between a recording position of approaching the transport belt and a separation position of being away from the transport belt, the destaticization unit is configured to move between a destaticization position of contacting the transport belt and a retraction position of being retracted from the transport belt, and, when the destaticization unit is retracted from the destaticization position to the retraction position, and then the destaticization unit is restored from the retraction position to the destaticization position, the control unit rotates the transport belt while the recording unit is at the separation position, until a contact portion of the transport belt passes through the cleaning unit, the contact portion contacting the destaticization unit restored to the destaticization position. When the destaticization unit is retracted from the destaticization position to the retraction position, the destaticization unit is restored from the retraction position to the destaticization position, a foreign matter easily adheres from the destaticization unit to the transport belt. When the transporting belt rotates, a foreign matter adhering to the transport belt can be removed by the cleaning unit. According to the above-mentioned configuration, the transport belt rotates while the recording unit is at the separation position. Thus, a foreign matter adhering to the transport belt is less likely to adhere to the recording unit. Therefore, a risk that a foreign matter adheres to the recording unit is lowered.
(B) In the above-mentioned recording device, the control unit may retract the destaticization unit from the destaticization position to the retraction position, and then start rotation of the transport belt while the recording unit is at the separation position. According to the above-mentioned configuration, when the destaticization unit is retracted from the destaticization position to the retraction position, a foreign matter adhering to the transport belt can effectively be removed by the cleaning unit.
(C) In the above-mentioned recording device, the control unit may retract the destaticization unit from the destaticization position to the retraction position, and, at the same time, start rotation of the transport belt while the recording unit is at the separation position. According to the above-mentioned configuration, when the destaticization unit is retracted from the destaticization position to the retraction position, a foreign matter adhering to the transport belt can effectively be removed by the cleaning unit.
(D) In the above-mentioned recording device, the control unit may start rotation of the transport belt while the recording unit is at the separation position, and then retract the destaticization unit from the destaticization position to the retraction position. According to the above-mentioned configuration, when the destaticization unit is retracted from the destaticization position to the retraction position, a foreign matter falling off therefrom can disperse on the transport belt. In other words, a risk that a foreign matter concentrates at one position on the transport belt is lowered. With this, a foreign matter adhering to the transport belt is easily removed by the cleaning unit.
(E) In the above-mentioned recording device, after the contact portion passes through the cleaning unit, the control unit may stop the transport belt. According to the above-mentioned configuration, the transport belt from which a foreign matter is removed can transport the medium.
(F) In the above-mentioned recording device, after the contact portion passes through the cleaning unit for a plurality of times, the control unit may stop the transport belt. According to the above-mentioned configuration, a foreign matter adhering to the transport belt can be removed repeatedly by the cleaning unit.
(G) In the above-mentioned recording device, the destaticization unit may include a rotary shaft, and may be configured to move between the destaticization position and the retraction position by rotating about the rotary shaft. According to the above-mentioned configuration, which is a simple configuration, the destaticization unit can move between the destaticization position and the retraction position.
(H) In the above-mentioned recording device, after the contact portion passes through the cleaning unit for a plurality of times, the control unit may stop the transport belt. In the middle of restoring the destaticization unit from the retraction position to the destaticization position, the destaticization unit contacts with the transport belt. In this state, the destaticization unit receives a frictional force from the rotating transport belt. According to the above-mentioned configuration, the destaticization unit is easily restored to the destaticization position by a frictional force received from the transport belt.
(I) The above-mentioned recording device may include a collection unit configured to collect a foreign matter from the destaticization unit, wherein the collection unit may collect a foreign matter from the destaticization unit by contacting the destaticization unit moving between the destaticization position and the retraction position. According to the above-mentioned configuration, a risk of degrading the destaticization performance of the destaticization unit is lowered.
(J) The above-mentioned recording device may include a counting unit configured to count the number of transported media, wherein, when the number of transported media counted by the counting unit reaches a predetermined number, the control unit may retract the destaticization unit from the destaticization position to the retraction position. According to the above-mentioned configuration, the collection unit can collect a foreign matter from the destaticization unit at a suitable timing.
(K) The above-mentioned recording device may include a cap configured to cap the recording unit, wherein the recording unit may be configured to eject a liquid onto the medium, and, when the recording unit is at the separation position, the recording unit may be capped by the cap. According to the above-mentioned configuration, the transport belt can be rotated while the recording unit is capped by the cap until the contact portion passes through the cleaning unit. With this, a risk that a foreign matter on the transport belt adheres to the recording unit can further be lowered.
(L) A control method for a recording device including a transport belt configured to transport a medium by electrostatic suction, a recording unit configured to record an image on a medium being transported by the transport belt, a destaticization unit positioned upstream in a transport direction of the medium with respect to the recording unit and configured to destaticize the medium transported by the transport belt, and a cleaning unit configured to contact the transport belt to clean the transport belt, the recording unit being configured to move between a recording position of approaching the transport belt and a separation position of being away from the transport belt, the destaticization unit being configured to move between a destaticization position of contacting the transport belt and a retraction position of being retracted from the transport belt, the control method includes, when the destaticization unit is retracted from the destaticization position to the retraction position, and then the destaticization unit is restored from the retraction position to the destaticization position, rotating the transport belt while the recording unit is at the separation position, until a contact portion of the transport belt passes through the cleaning unit, the contact portion contacting the destaticization unit restored to the destaticization position. According to the above-mentioned method, effects similar to those of the recording device described above can be exerted.
(M) The above-mentioned control method for a recording device may include retracting the destaticization unit from the destaticization position to the retraction position, and then starting rotation of the transport belt while the recording unit is at the separation position. According to the above-mentioned method, effects similar to those of the recording device described above can be exerted.
(N) The above-mentioned control method for a recording device may include retracting the destaticization unit from the destaticization position to the retraction position, and, at the same time, starting rotation of the transport belt while the recording unit is at the separation position. According to the above-mentioned method, effects similar to those of the recording device described above can be exerted.
(O) The above-mentioned control method for a recording device may include starting rotation of the transport belt while the recording unit is at the separation position, and then retracting the destaticization unit from the destaticization position to the retraction position. According to the above-mentioned method, effects similar to those of the recording device described above can be exerted.
(P) The above-mentioned control method for a recording device may include stopping the transport belt after the contact portion passes through the cleaning unit. According to the above-mentioned method, effects similar to those of the recording device described above can be exerted.

What is claimed is:

1. A recording device, comprising:
a transport belt configured to transport a medium by electrostatic suction;
a recording unit configured to record an image on a medium being transported by the transport belt;
a destaticization unit positioned upstream in a transport direction of the medium with respect to the recording unit and configured to destaticize the medium being transported by the transport belt;
a cleaning unit configured to contact the transport belt to clean the transport belt; and
a control unit, wherein
the recording unit is configured to move between a recording position of approaching the transport belt and a separation position of being away from the transport belt,
the destaticization unit is configured to move between a destaticization position of contacting the transport belt and a retraction position of being retracted from the transport belt, and
when the control unit retracts the destaticization unit from the destaticization position to the retraction position, and then restores the destaticization unit from the retraction position to the destaticization position, the control unit rotates the transport belt while the recording unit is at the separation position, until a contact portion of the transport belt passes through the cleaning unit, the contact portion contacting the destaticization unit restored to the destaticization position.

2. A recording device according to claim 1, wherein
the control unit retracts the destaticization unit from the destaticization position to the retraction position, and then starts rotation of the transport belt while the recording unit is at the separation position.

3. A recording device according to claim 1, wherein
the control unit retracts the destaticization unit from the destaticization position to the retraction position, and, at the same time, starts rotation of the transport belt while the recording unit is at the separation position.

4. A recording device according to claim 1, wherein
the control unit starts rotation of the transport belt while the recording unit is at the separation position, and then retracts the destaticization unit from the destaticization position to the retraction position.

5. A recording device according to claim 1, wherein
after the contact portion passes through the cleaning unit, the control unit stops the transport belt.

6. A recording device according to claim 5, wherein
after the contact portion passes through the cleaning unit for a plurality of times, the control unit stops the transport belt.

7. A recording device according to claim 1, wherein
the destaticization unit includes a rotary shaft, and is configured to move between the destaticization position and the retraction position by rotating about the rotary shaft.

8. A recording device according to claim 7, wherein
a rotation direction of the transport belt is a direction opposite to a rotation direction of the destaticization unit when the destaticization unit is restored from the retraction position to the destaticization position.

9. A recording device according to claim 1, comprising
a collection unit configured to collect a foreign matter from the destaticization unit, wherein
the collection unit collects a foreign matter from the destaticization unit by contacting the destaticization unit moving between the destaticization position and the retraction position.

10. A recording device according to claim 9, comprising
a counting unit configured to count the number of transported media, wherein
when the number of transported media counted by the counting unit reaches a predetermined number, the control unit retracts the destaticization unit from the destaticization position to the retraction position.

11. A recording device according to claim 10, comprising
a cap configured to cap the recording unit, wherein
the recording unit is configured to eject a liquid onto the medium, and
when the recording unit is at the separation position, the recording unit is capped by the cap.

12. A control method for a recording device, the recording device comprising:
a transport belt configured to transport a medium by electrostatic suction;
a recording unit configured to record an image on a medium being transported by the transport belt;
a destaticization unit positioned upstream in a transport direction of the medium with respect to the recording unit and configured to destaticize the medium being transported by the transport belt; and
a cleaning unit configured to contact the transport belt to clean the transport belt,
the recording unit being configured to move between a recording position of approaching the transport belt and a separation position of being away from the transport belt,
the destaticization unit being configured to move between a destaticization position of contacting the transport belt and a retraction position of being retracted from the transport belt,
the control method comprising
when the destaticization unit is retracted from the destaticization position to the retraction position, and then the destaticization unit is restored from the retraction position to the destaticization position, rotating the transport belt while the recording unit is at the separation position, until a contact portion of the transport belt passes through the cleaning unit, the contact portion contacting the destaticization unit restored to the destaticization position.

13. A control method for a recording device according to claim 12, the control method comprising
after retracting the destaticization unit from the destaticization position to the retraction position, starting rotation of the transport belt while the recording unit is at the separation position.

14. A control method for a recording device according to claim 12, the control method comprising
starting rotation of the transport belt while the recording unit is at the separation position at the same time as retracting the destaticization unit from the destaticization position to the retraction position.

15. A control method for a recording device according to claim 12, the control method comprising
retracting the destaticization unit from the destaticization position to the retraction position after starting rotation of the transport belt while the recording unit is at the separation position.

16. A control method for a recording device according to claim 12, the control method comprising
stopping the transport belt after the contact portion passes through the cleaning unit.
